(19) United States
(12) Patent Application Publication
(10) Pub. No.: US 2014/0002415 A1
(43) Pub. Date: Jan. 2, 2014

(54) TOUCH SENSING APPARATUS AND TOUCH SENSING METHOD

(71) Applicant: RAYDIUM SEMICONDUCTOR CORPORATION, Hsinchu (TW)

(72) Inventor: Sheng-Fu Wang, Tainan City (TW)

(21) Appl. No.: 13/930,781

(22) Filed: Jun. 28, 2013

(30) Foreign Application Priority Data
Jun. 29, 2012 (TW) 101123602

(51) Int. Cl. G06F 3/044

(52) U.S. Cl. CPC G06F 3/044
USPC 345/174

(57) ABSTRACT

A touch sensing apparatus and a touch sensing method applied in a capacitive touch panel are disclosed. The touch sensing apparatus includes a driving module, a plurality of driving lines, a plurality of sensing lines, and a sensing module. The driving module is used to provide a plurality of driving signals. The plurality of driving lines is coupled to the driving module and correspondingly receives the plurality of driving signals respectively. The plurality of sensing lines correspondingly senses and outputs a plurality of sensing signals respectively. The sensing module determines touch point location on the capacitive touch panel according to a plurality of differences between each of the sensing signals and adjacent sensing signals. A driving electrode area of the plurality of driving lines is larger than a sensing electrode area of the plurality of sensing lines.

### BACKGROUND OF THE INVENTION

1. Field of the Invention

The invention relates to a capacitive touch panel; in particular, to a touch sensing apparatus and a touch sensing method applied in the capacitive touch panel.

2. Description of the Related Art

In recent years, with the rapid development of technology, the conventional display has been gradually replaced by the liquid crystal display, and the liquid crystal display has been widely used in various electronic products such as television, flat display, mobile phone, tablet computer, and projector. For the liquid crystal display having the touch function, the touch sensor is one of its important modules and the entire performance of the liquid crystal display is also directly affected by the performance of the touch sensor.

Please refer to FIG. 1A and FIG. 1B. FIG. 1A and FIG. 1B illustrate schematic diagrams of the conventional touch sensor using differential method to sense touch points on the capacitive touch panel. Wherein, FIG. 1A illustrates the condition of the capacitive touch panel which is not touched; FIG. 1B illustrates the condition of the capacitive touch panel which is touched.

As shown in FIG. 1A, when the capacitive touch panel TP is not touched, a plurality of driving lines D1˜D5 are charged in order. When the driving lines D1˜D5 are charged, each of a plurality of sensing lines S1˜S5 senses a sensing signal respectively. Since the differential method is to detect the differences between two sensing signals of two adjacent sensing lines, and the sensing signals corresponding to the sensing lines S1˜S5 are the same, the differences between two sensing signals of two adjacent sensing lines will be zero.

On the contrary, as shown in FIG. 1B, when the capacitive touch panel TP is touched, if the touch point is located on a node position P22 that the driving line D2 and the sensing line S2 intersect, the sensing signal value of the sensing line S2 will be lower; therefore, a sensing signal difference will be formed between the sensing signal of the sensing line S2 and the sensing signals of the adjacent sensing lines S1 and S3. The touch sensor can determine the touch point locations on the capacitive touch panel TP according to this difference.

However, since the current electrode design method of using the plurality of driving lines D1˜D5 and the plurality of sensing lines S1˜55 on the capacitive touch panel TP fails to lower the capacitance value of the sensing line to ground (or the mutual capacitance value C_{M} between the sensing lines S1˜55 and the reference voltage V_{com} of the liquid crystal module LCM under the sensing lines S1˜55, as shown in FIG. 2) and the mutual capacitance values between the sensing lines and the driving lines are not large enough, and the sensing signal difference between the sensing line corresponding to the touch point and the adjacent sensing line is not large enough, so that the touch point sensing accuracy of the conventional touch sensor performed on the capacitive touch panel TP will be lowered.

### SUMMARY OF THE INVENTION

Therefore, the invention provides a touch sensing apparatus and a touch sensing method applied in the capacitive touch panel to solve the above-mentioned problems occurred in the prior arts.

A preferred embodiment of the invention is a touch sensing apparatus. In the embodiment, the touch sensing apparatus is applied in a capacitive touch panel. The touch sensing apparatus includes a driving module, a plurality of driving lines, a plurality of sensing lines, and a sensing module. The driving module is used to provide a plurality of driving signals. The plurality of driving lines is coupled to the driving module and correspondingly receives the plurality of driving signals respectively. The plurality of sensing lines correspondingly senses and outputs a plurality of sensing signals respectively. The sensing module determines touch point location on the capacitive touch panel according to a plurality of differences between each of the sensing signals and adjacent sensing signals. A driving electrode area of the plurality of driving lines is larger than a sensing electrode area of the plurality of sensing lines.

In an embodiment, the plurality of driving lines and the plurality of sensing lines are disposed on the same plane, and the plurality of driving lines and the plurality of sensing lines are cross-arranged without connecting to each other to increase an electrode mutual inductance area between the plurality of driving lines and the plurality of sensing lines.

In an embodiment, an electrode gap between the plurality of driving lines and the plurality of sensing lines is filled by a floating electrode having no connection to the plurality of driving lines and the plurality of sensing lines.

In an embodiment, the plurality of driving lines and the plurality of sensing lines are disposed on the different planes.

In an embodiment, the plurality of driving lines is a large-area electrode disposed on a plane and the plurality of sensing lines is a grid electrode disposed on another plane.

In an embodiment, a driving electrode gap between the plurality of driving lines on the plane is filled by a floating electrode or a ground electrode having no connection to the plurality of driving lines.

In an embodiment, a sensing electrode gap between the plurality of sensing lines on the another plane is filled by a floating electrode having no connection to the plurality of sensing lines.

Another embodiment of the invention is a touch sensing method. In the embodiment, the touch sensing method is applied to a capacitive touch panel. The touch sensing method includes steps of: (a) a plurality of driving lines correspondingly receiving the plurality of driving signals respectively; (b) a plurality of sensing lines correspondingly sensing and outputting a plurality of sensing signals respectively; (c) calculating a plurality of differences between each of the plurality of sensing signals and adjacent sensing signals; (d) determining a touch point location on the capacitive touch panel according to the plurality of differences. A driving electrode area of the plurality of driving lines is larger than a sensing electrode area of the plurality of sensing lines.

Compared to the prior arts, the touch sensing apparatus and method of the invention is applied to sense touch points on the capacitive touch panel, the electrode design that a driving electrode area of the driving lines is larger than a sensing electrode area of the sensing lines is used to reduce the capacitance value of the sensing line to ground, and the electrode design that the driving lines and the sensing lines are disposed on the same plane, and the driving lines and the sensing lines are cross-arranged without connecting to each other or the driving lines and the sensing lines are a large-area electrode or a grid electrode disposed on the different planes to increase an electrode mutual inductance area between the driving lines and the sensing lines to increase the mutual capacitance value. Therefore, the sensing signal difference between the sensing line corresponding to the touch point and the adjacent sensing line become larger, so that the touch point sensing accuracy of the touch sensor performed on the capacitive touch panel can be increased, and it can be used in the capacitive touch panel of any size.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A and FIG. 1B illustrate schematic diagrams of the conventional touch sensor using differential method to sense touch points on the capacitive touch panel.

FIG. 2 illustrates a schematic diagram of the mutual capacitance generated between the sensing lines and the reference voltage of the liquid crystal module under the sensing lines.

FIG. 3 illustrates a schematic diagram of the plurality of driving lines and the plurality of sensing lines disposed on the same plane.

FIG. 4 illustrates a node that the electrode of single driving line and the electrode of single sensing line intersect.

FIG. 5A and FIG. 5B illustrate embodiments of another two nodes.

FIG. 6 illustrates a schematic diagram of the plurality of driving lines and the plurality of sensing lines disposed on different planes.

FIG. 7A illustrates a part of the driving line disposed on the first plane.

FIG. 7B illustrates a part of the sensing line disposed on the second plane.

FIG. 7C˜FIG. 7E illustrate the grid sensing electrodes of different forms distributed above the large-area driving electrode.

FIG. 8 illustrates a flowchart of the touch sensing method in another embodiment of the invention.

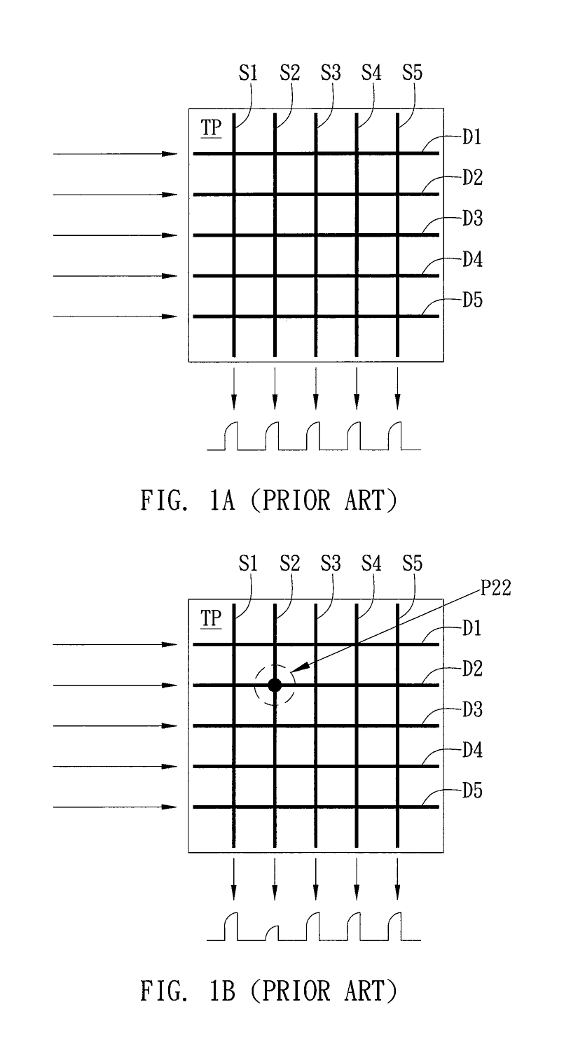

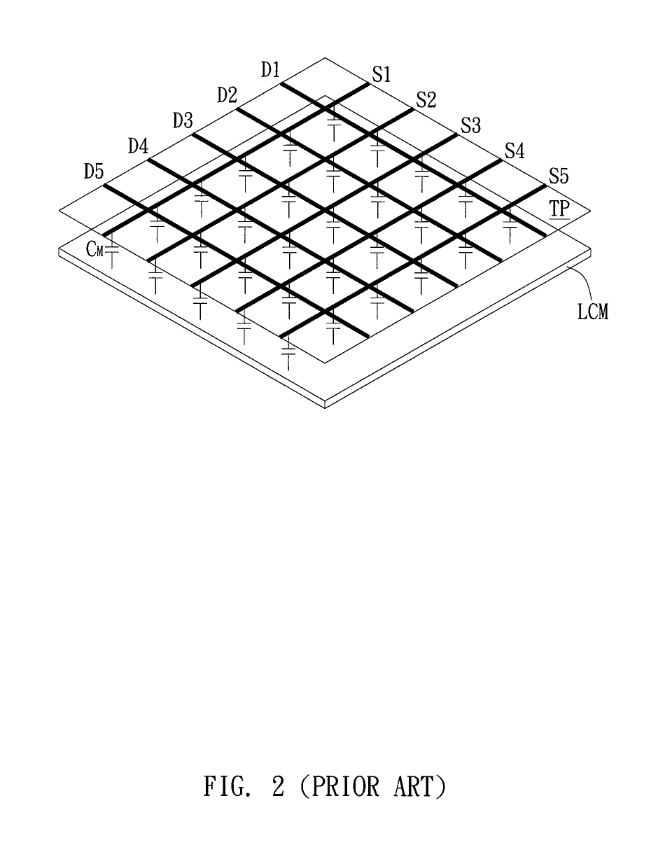

### DETAILED DESCRIPTION

A preferred embodiment of the invention is a touch sensing apparatus. In the embodiment, the touch sensing apparatus is applied in a capacitive touch panel, but not limited to this.

The touch sensing apparatus of the invention includes a driving module, a plurality of driving lines, a plurality of sensing lines, and a sensing module. The driving module is used to provide a plurality of driving signals. The plurality of driving lines is coupled to the driving module and correspondingly receives the plurality of driving signals respectively. The plurality of sensing lines correspondingly senses and outputs a plurality of sensing signals respectively. The sensing module determines touch point location on the capacitive touch panel according to a plurality of differences between each of the sensing signals and adjacent sensing signals.

The touch sensor of the invention uses the differential method to sense touch points on the capacitive touch panel. When the capacitive touch panel is not touched, a plurality of driving lines is charged by the driving module in order. When the driving lines are charged, each of a plurality of sensing lines senses a sensing signal respectively. Since the differential method is to detect the differences between two sensing signals of two adjacent sensing lines, and the sensing signals corresponding to the sensing lines are the same, the differences between two sensing signals of two adjacent sensing lines will be zero. When the capacitive touch panel is touched by a conductor, if the touch point is located on a node position that the driving line and the sensing line intersect, the sensing signal value of the sensing line will be lower; therefore, a sensing signal difference will be formed between the sensing signal of the sensing line and the sensing signals of the adjacent sensing lines. The sensing module can determine the touch point locations on the capacitive touch panel according to this difference.

It should be noticed that in this invention, a driving electrode area of the plurality of driving lines is larger than a sensing electrode area of the plurality of sensing lines to reduce the capacitance value of the sensing line to ground or reduce the mutual capacitance generated between the sensing lines and the reference voltage (V_{com}) of the liquid crystal module under the sensing lines to increase the sensing signal difference between the sensing line corresponding to the touch point and the adjacent sensing line.

From the point of electrode design, the electrodes of the driving lines and the sensing lines are disposed on the capacitive touch panel, and the electrodes of the driving lines and the sensing lines can be arranged on the same plane or different planes based on practical needs. Next, these two different electrode design methods will be introduced as follows.

At first, the condition of the electrodes of the driving lines and the sensing lines can be arranged on the same plane will be introduced. It can be used in the glass single layer manufacturing process structure, such as the glass on glass (GOG) or the one glass solution (OGS), but not limited to this.

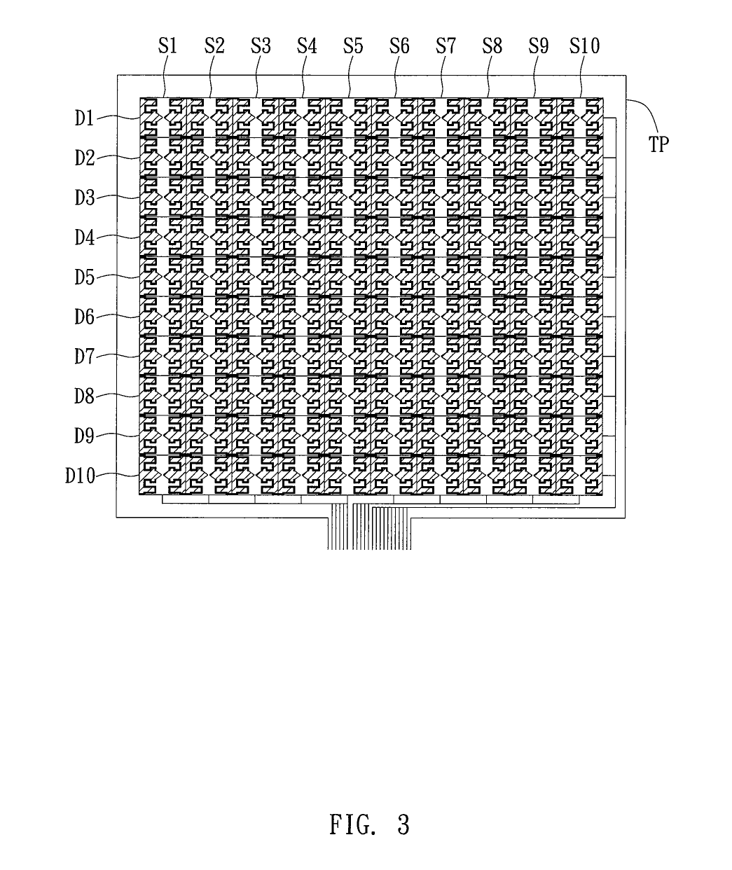

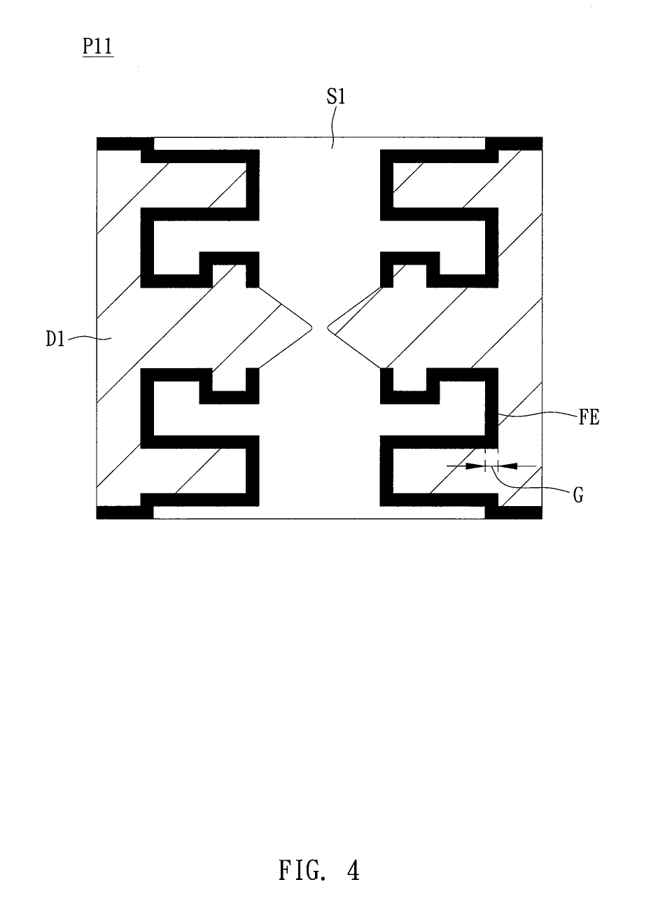

Please refer to FIG. 3. FIG. 3 illustrates a schematic diagram of the plurality of driving lines and the plurality of sensing lines disposed on the same plane. As shown in FIG. 3, the design of the ITO conductive glass is to use a node (as shown in FIG. 4) that the electrode of single driving line and the electrode of single sensing line intersect as a unit to expand to be a matrix. The horizontally arranged driving lines D1˜D10 and vertically arranged sensing lines S1˜S10 are disposed on the same plane. If FIG. 4 shows the node P11 that the driving electrode of the first driving line D1 and the sensing electrode of the first sensing line S1 intersect and the electrode gap G between the driving electrode and the sensing electrode can be filled by a floating electrode FE having no connection to the first driving line D1 and the first driving line D1. In fact, the driving electrode and the sensing electrode can be formed by any conductive material, and the floating electrode FE can be formed by the ITO conductive glass material, but not limited to this.

It should be noticed that in the node P11 of FIG. 4, the driving electrode area of the first driving line D1 is larger than the sensing electrode area of the first sensing line S1. Similarly, since the designs of driving electrodes and sensing electrodes in each node are the same, in other nodes P12˜P1010, the driving electrode area of the driving line corresponding to a specific node is larger than the sensing electrode area of the sensing line corresponding to the specific node.

Therefore, the total driving electrode area of all driving lines D1˜D10 is larger than the total sensing electrode area of all sensing lines S1˜S10. This electrode design can effectively increase the electrode mutual inductance area between the driving lines and the sensing lines to increase the mutual capacitance value. Therefore, the sensing signal difference between the sensing line corresponding to the touch point and the adjacent sensing line will become larger, and the touch point sensing accuracy of the touch sensor performed on the capacitive touch panel can be increased, and it can be used to sense the touch of smaller size (e.g., an area of 2 mm diameter).

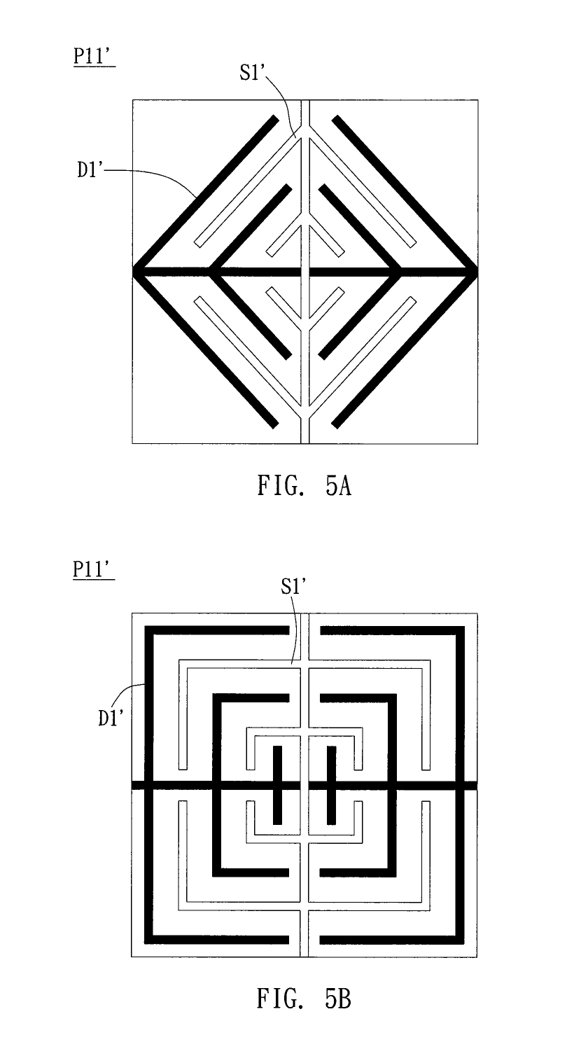

Please refer to FIG. 5A and FIG. 5B. FIG. 5A and FIG. 5B illustrate embodiments of another two nodes. In these nodes P11′, the driving lines D1′ and the sensing lines S1′ are cross-arranged on the same plane, and the driving electrode area of the driving lines D1′ is larger than the sensing electrode area of the sensing lines S1′.

Then, the condition of the electrodes of the driving lines and the sensing lines can be arranged on different planes will be introduced. It can be used in the dual layer structure of separate driving lines and sensing lines, such as the glass-film-film (GFF) structure or glass-film (G1F) structure, but not limited to this.

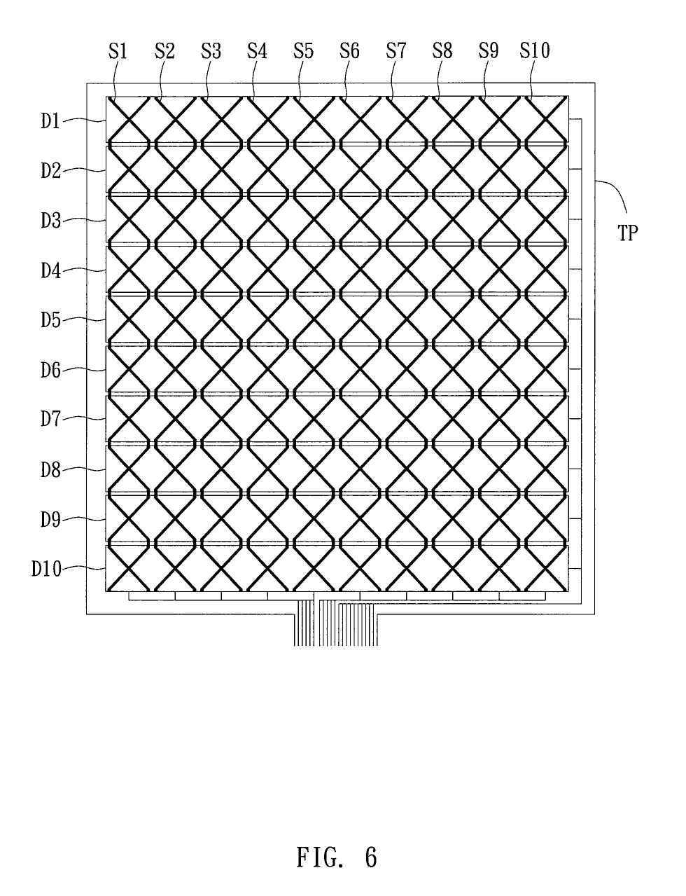

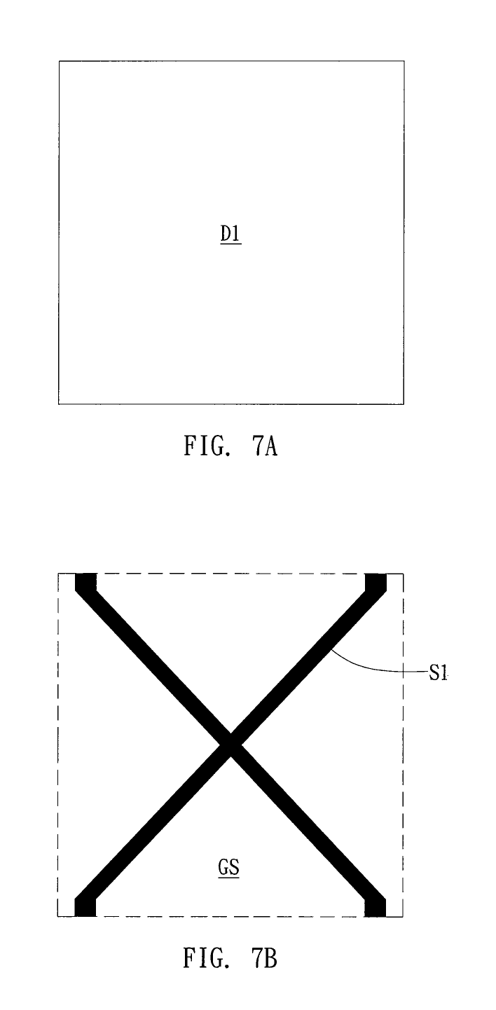

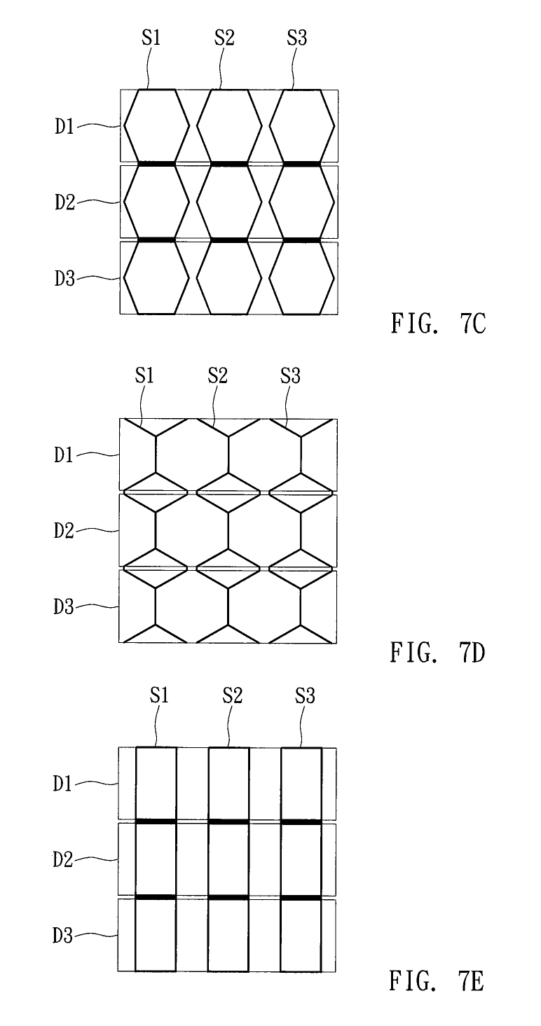

Please refer to FIG. 6, FIG. 7A, and FIG. 7B. FIG. 6 illustrates a schematic diagram of the plurality of driving lines and the plurality of sensing lines disposed on different planes. FIG. 7A illustrates a part of the driving line disposed on the first plane. FIG. 7B illustrates a part of the sensing line disposed on the second plane. As shown in these figures, the driving lines D1˜D10 are disposed on the lower first plane in a form of large-area driving electrode, and the sensing lines S1˜S10 are disposed on the upper second plane in a form of grid sensing electrode. The driving lines D1˜D10 are all independent driving electrodes having no connection to each other, and the sensing lines S1˜S10 are all independent sensing electrodes having no connection to each other. That is to say, each of the driving lines D1˜D10 will be not electrically connected to adjacent driving lines, and each of the sensing lines S1˜S10 will be not electrically connected to adjacent sensing lines.

It should be noticed that the aim that the driving lines D1˜D10 are disposed on the lower first plane in a form of large-area driving electrode without any limitations to its shape is to make the driving electrode area of the driving lines larger than the sensing electrode area of the sensing lines to reduce the capacitance value of the sensing electrode to ground in the touch panel system. That is to say, if the driving electrode area of the driving lines can be larger than the sensing electrode area of the sensing lines, the shape of the driving lines D1˜D10 disposed on the first plane has no specific limitations.

The aim of the sensing lines S1˜S10 disposed on the upper second plane in a form of grid sensing electrode without any limitations to its type is to reduce the sensing electrode volume of the sensing lines and use fine line width to enlarge its distribution range to increase the electrode mutual inductance area between the driving lines and the sensing lines to increase the mutual capacitance value, and it can be used to sense the touch of smaller size (e.g., an area of 2 mm diameter). As shown in FIG. 7C˜FIG. 7E, the driving lines D1˜D3 and the sensing lines S1˜S3 are illustrated to show the grid sensing electrodes of different forms distributed above the large-area driving electrode.

As shown in these figures, a driving electrode gap GD between the driving lines can be filled by a floating electrode or a ground electrode having no connection to the driving lines. A sensing electrode gap GS between the plurality of sensing lines can be filled by a floating electrode having no connection to the sensing lines. In fact, the driving electrode and the sensing electrode can be formed by any conductive material, and the floating electrode FE can be formed by the ITO conductive glass material, but not limited to this.

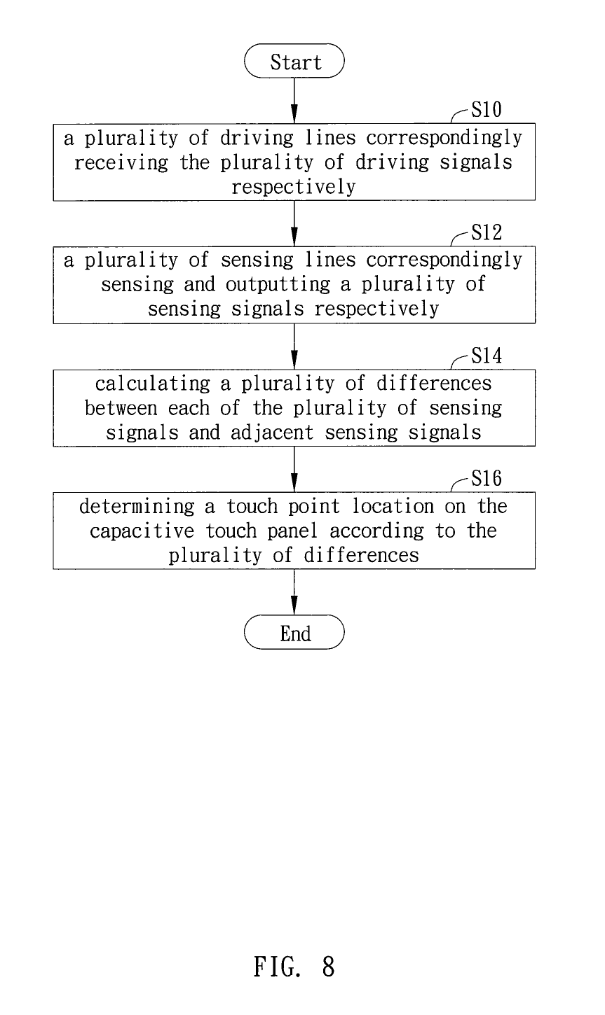

Another embodiment of the invention is a touch sensing method. In the embodiment, the touch sensing method is applied to a capacitive touch panel. Please refer to FIG. 8. FIG. 8 illustrates a flowchart of the touch sensing method in this embodiment.

As shown in FIG. 8, in the step S10, a plurality of driving lines correspondingly receives the plurality of driving signals respectively. In the step S12, a plurality of sensing lines correspondingly senses and outputs a plurality of sensing signals respectively. In the step S14, the method calculates a plurality of differences between each of the plurality of sensing signals and adjacent sensing signals. In the step S16, the method determines a touch point location on the capacitive touch panel according to the plurality of differences. A driving electrode area of the plurality of driving lines is larger than a sensing electrode area of the plurality of sensing lines.

In practical applications, if the plurality of driving lines and the plurality of sensing lines are disposed on the same plane, and the plurality of driving lines and the plurality of sensing lines are cross-arranged without connecting to each other to increase an electrode mutual inductance area between the plurality of driving lines and the plurality of sensing lines. An electrode gap between the plurality of driving lines and the plurality of sensing lines is filled by a floating electrode having no connection to the plurality of driving lines and the plurality of sensing lines.

In addition, if the plurality of driving lines and the plurality of sensing lines are disposed on the different planes, the plurality of driving lines is a large-area electrode disposed on a plane and the plurality of sensing lines is a grid electrode disposed on another plane. A driving electrode gap between the plurality of driving lines on the plane is filled by a floating electrode or a ground electrode having no connection to the plurality of driving lines. A sensing electrode gap between the plurality of sensing lines on the another plane is filled by a floating electrode having no connection to the plurality of sensing lines.

Compared to the prior arts, the touch sensing apparatus and method of the invention is applied to sense touch points on the capacitive touch panel, the electrode design that a driving electrode area of the driving lines is larger than a sensing electrode area of the sensing lines is used to reduce the capacitance value of the sensing line to ground, and the electrode design that the driving lines and the sensing lines are disposed on the same plane, and the driving lines and the sensing lines are cross-arranged without connecting to each other or the driving lines and the sensing lines are a large-area electrode or a grid electrode disposed on the different planes to increase an electrode mutual inductance area between the driving lines and the sensing lines to increase the mutual capacitance value. Therefore, the sensing signal difference between the sensing line corresponding to the touch point and the adjacent sensing line become larger, so that the touch point sensing accuracy of the touch sensor performed on the capacitive touch panel can be increased, and it can be used in the capacitive touch panel of any size.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A touch sensing apparatus, applied to a capacitive touch panel, the touch sensing apparatus comprising:
a driving module, for providing a plurality of driving signals;
a plurality of driving lines, coupled to the driving module, the plurality of driving lines correspondingly receiving the plurality of driving signals respectively;
a plurality of sensing lines, correspondingly sensing and outputting a plurality of sensing signals respectively; and
a sensing module, coupled to the plurality of sensing lines, for determining a touch point location on the capacitive touch panel according to a plurality of differences between each of the plurality of sensing signals and adjacent sensing signals;
wherein a driving electrode area of the plurality of driving lines is larger than a sensing electrode area of the plurality of sensing lines.

2. The touch sensing apparatus of claim 1, wherein the plurality of driving lines and the plurality of sensing lines are disposed on the same plane, and the plurality of driving lines and the plurality of sensing lines are cross-arranged without connecting to each other to increase an electrode mutual inductance area between the plurality of driving lines and the plurality of sensing lines.

3. The touch sensing apparatus of claim 2, wherein an electrode gap between the plurality of driving lines and the plurality of sensing lines is filled by a floating electrode having no connection to the plurality of driving lines and the plurality of sensing lines.

4. The touch sensing apparatus of claim 1, wherein the plurality of driving lines and the plurality of sensing lines are disposed on the different planes.

5. The touch sensing apparatus of claim 4, wherein the plurality of driving lines is a large-area electrode disposed on a plane and the plurality of sensing lines is a grid electrode disposed on another plane.

6. The touch sensing apparatus of claim 5, wherein a driving electrode gap between the plurality of driving lines on the plane is filled by a floating electrode or a ground electrode having no connection to the plurality of driving lines.

7. The touch sensing apparatus of claim 5, wherein a sensing electrode gap between the plurality of sensing lines on the another plane is filled by a floating electrode having no connection to the plurality of sensing lines.

8. A touch sensing method, applied to a capacitive touch panel, the touch sensing method comprising steps of:
(a) a plurality of driving lines correspondingly receiving the plurality of driving signals respectively;
(b) a plurality of sensing lines correspondingly sensing and outputting a plurality of sensing signals respectively;
(c) calculating a plurality of differences between each of the plurality of sensing signals and adjacent sensing signals; and
(d) determining a touch point location on the capacitive touch panel according to the plurality of differences;
wherein a driving electrode area of the plurality of driving lines is larger than a sensing electrode area of the plurality of sensing lines.

9. The touch sensing method of claim 8, wherein the plurality of driving lines and the plurality of sensing lines are disposed on the same plane, and the plurality of driving lines and the plurality of sensing lines are cross-arranged without connecting to each other to increase an electrode mutual inductance area between the plurality of driving lines and the plurality of sensing lines.

10. The touch sensing method of claim 9, wherein an electrode gap between the plurality of driving lines and the plurality of sensing lines is filled by a floating electrode having no connection to the plurality of driving lines and the plurality of sensing lines.

11. The touch sensing method of claim 8, wherein the plurality of driving lines and the plurality of sensing lines are disposed on the different planes.

12. The touch sensing method of claim 11, wherein the plurality of driving lines is a large-area electrode disposed on a plane and the plurality of sensing lines is a grid electrode disposed on another plane.

13. The touch sensing method of claim 12, wherein a driving electrode gap between the plurality of driving lines on the plane is filled by a floating electrode or a ground electrode having no connection to the plurality of driving lines.

14. The touch sensing method of claim 12, wherein a sensing electrode gap between the plurality of sensing lines on the another plane is filled by a floating electrode having no connection to the plurality of sensing lines.
